(19) United States
(12) Patent Application Publication
(10) Pub. No.: US 2005/0144501 A1
(43) Pub. Date: Jun. 30, 2005

(54) Method for recovering data in EXT2 file system, and computer-readable storage medium recorded with data-recovery program

(76) Inventors: Jae Gon Kim, Gwangmyeong-si (KR); Ju Hwan Sheen, Seoul (KR)

Correspondence Address: Wilson & Ham;PMB: 348, 2530 Berryessa Road, San Jose, CA, 95132, US

(21) Appl. No.: 10/999,070

(22) Filed: Nov. 29, 2004

(30) Foreign Application Priority Data
Dec. 2, 2003 (KR) 2003-86702

(51) Int. Cl. G06F 11/00

(52) U.S. Cl. 714/2

(57) ABSTRACT

The present invention provides a data recovery method for EXT2 file system without pre-installing an additional program and a computer readable storage medium storing the data recovery program. The method includes extracting partition table from a storage medium stored data to be recovered, extracting entries of directories and files from a partition using the extracted partition table, extracting the data corresponding to the entries, and combining the extracted data so as to be stored as a new file, whereby it is possible to recover the files damaged or deleted without the previously installed additional program.

### CROSS-REFERENCE TO RELATED APPLICATIONS

This application claims the benefit of Korean Patent Application No. 2003-86702 filed in the Korean Intellectual Property Office on Dec. 2, 2003, which is incorporated herein in its entirety by reference.

### FIELD OF THE INVENTION

The present invention relates to a data recovery method for a second extend file system (EXT2) and a computer readable storage medium containing the data recovery program and, more particularly, to the data recovery method of the EXT2 file system, which is capable of performing the recovery operation without pre-installing an additional program, and the computer readable storage medium containing the data recovery program.

### BACKGROUND OF THE INVENTION

Recently, as the data processing rate of computers increases, the amount of information is explosively tending to increase in comparison with past years. Along with the increase of information, storage technologies and mediums have been developed.

Even though various storage media are utilized for storing massive data, those data might be lost by outside impacts, collisions between programs, or computer viruses.

Even though data backup program can be utilized for the purpose of having a second copy of the data, there can be data of which backup is not carried out such that it is impossible to recover the original data.

In order to solve these problems various data recovery methods have been proposed. However, the conventional data recovery methods have a drawback in that a monitoring program should be previously installed for backup.

Also, the conventional data recovery programs which run on the well-known computer operating systems such as Windows and Linux have been specified as for the specific file systems. That is, the data recovery program based on Windows must not run on Linux.

### SUMMARY OF THE INVENTION

The present invention has been made in an effort to solve the above problems, and it is an object of the present invention to provide a data recovery method for EXT2 file system, which is capable of recovering the damaged or lost data without previously installed data recovery program, and a computer readable storage medium containing the data recovery method as an executable program.

It is another object of the present invention to provide a data recovery method for EXT2 file system which is capable of recovering the damaged data even when a disk is not identified due to a loss of a partition table in a Master Boot Recode (MBR) region and a computer readable storage medium contained the data recovery method as an executable program.

It is still another object of the present invention to provide a data recovery method for EXT2 file system, which is capable of recovering the damaged data even when the computer is not booted due to the abnormality of a super block, and a computer readable storage medium containing the data recovery method as a computer executable program.

In order to achieve the above objects, in one aspect of the present invention, a data recovery method for a Second Extend File System (EXT2) includes extracting partition table from a storage medium stored data to be recovered, extracting entries of directories and files from a partition using the extracted partition table, extracting the corresponding data using the entries, and combining the extracted data so as to be stored as a new file.

The step of extracting the entries includes extracting super block information from the partition, extracting group descriptor information using the super block information, and extracting the directory and file entries of all the level under a root directory referring to an Inode table which is indicated by the group descriptor information.

The step of extracting the super block information includes checking whether or not the super block are damaged and extracting the super block that are not damaged.

The step of extracting the entries further includes checking whether or not the partition is for the EXT2 file system.

The step of extracting the partition table includes reading the storage medium in unit of sector when the partition table is damaged and checking whether the data matching with a predetermined file system type exists.

The new file is stored in an exterior storage device or other partition different from the partition in which the data to be recovered are stored.

In another aspect of the present invention, the step of extracting the entries includes extracting super block information from the partition, extracting group descriptors information using the super block information; and extracting entries of the directories and files of which Inode number fields are cleared referring to an Inode table indicated by the group descriptor information.

The directories and files are indicated in the Inode table so as to have deletion times.

In another aspect of the present invention, a computer readable storage medium storing a data recovery program for a Second Extend File System (EXT2), the program including the processes of extracting partition table from a storage medium stored data to be recovered, extracting entries of directories and files from a partition using the extracted partition table, extracting the corresponding data using the entries, and combining the extracted data so as to be stored as a new file.

The process of extracting the entries includes extracting super block information from the partition, extracting group descriptor information using the super block information, and extracting the directory and file entries of all the level under a root directory referring to an Inode table which is indicated by the group descriptor information.

The process of extracting the super block information includes checking whether or not the super block are damaged and extracting the super block that are not damaged.

The process of extracting the entries further includes checking whether or not the partition is for the EXT2 file system.

The process of extracting the partition table includes reading the storage medium in unit of sector when the partition table is damaged and checking whether the data matching with a predetermined file system type exists.

The new file is stored in an exterior storage device or other partition different from the partition in which the data to be recovered are stored.

In another aspect of the present invention, the process of extracting the entries includes extracting super block information from the partition, extracting group descriptor information using the super block information and extracting entries of the directories and files of which Inode number fields are cleared referring to and Inode table indicated by the group descriptor information.

The directories and files are indicated in the Inode table so as to have deletion times.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram illustrating the EXT2 file system.

FIG. 2 is a drawing for illustrating a structure of an Inode.

FIG. 3 is a drawing schematically illustrating a structure of the directory entry existing in the data block.

FIG. 4 is a drawing illustrating an Inode table and a data block representing entire structure of the directory tree.

FIG. 5 is a flowchart illustrating a data recovery method of an EXT2 file system according to an embodiment of the present invention.

### DETAILED DESCRIPTION

Embodiments of the present invention will be described hereinafter with reference to the accompanying drawings.

An embodiment of the present invention proposes a method for recovering the lost or damaged data and a system implemented for supporting the data recovery method in an EXT2 file system.

An embodiment of the present invention also proposes a computer readable storage medium containing the data recovery method as a program which is implemented so as to be executed in a computer system. The storage medium can be any of a magnetic storage medium such as floppy disc, hard disc, etc. and an optical storage medium such as compact disc (CD), digital video disc (DVD), etc.

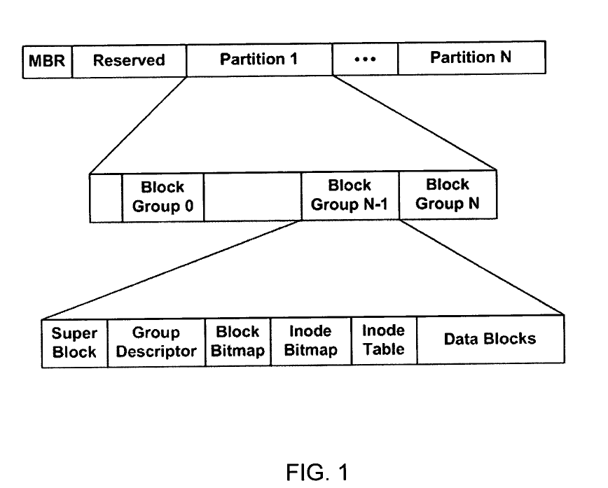

To help understand the invention, a structure of the EXT2 file system is first introduced. FIG. 1 is a block diagram illustrating the EXT2 file system.

As shown in FIG. 1, a typical hard disc has a logical structure including a master boot record (MBR) and one or more partitions. The MBR contains information on the boot and partition allocations.

In the EXT2 file system, the partition consists of one or more block groups, each of which includes a Super block, a Group Descriptor, a Block Bitmap, an Inode Bitmap, an Inode Table, and Data Blocks.

The Super Block contains information about size, type, and the like related to the file system with 1024 bytes as follows. The Super Block of a Block Group 0 is positioned at an offset of 1024 bytes from a start point of the Block Group and the Super Block of every Block Groups maintain an identical content.

```
struct ext2_super_block {
  _{——}u32 s_inodes_count;  /* Inodes count*/
  _{——}u32 s_blocks_count;  /* Blocks count */
  _{——}u32 s_r_blocks_count;  /* Reserved Blocks count */
  _{——}u32 s_free_blocks_count;  /* Free Blocks count */
  _{——}u32 s_free_inodes_count;  /* Free Inodes count */
  _{——}u32 s_first_data_block;  /* First Data Block */
  _{——}u32 s_log_block_size;  /* Block size */
  _{——}s32 s_log_frag_size;  /* Fragment size */
  _{——}u32 s_blocks_per_group;  /* # Blocks per Group */
  _{——}u32 s_frags_per_group;  /* # Fragments per Group*/
  _{——}u32 s_inodes_per_group;  /* # Inodes per Group */
  _{——}u32 s_mtime;  /* Mount time */
  _{——}u32 s_wtime;  /* write time */
  _{——}u16 s_mnt_count;  /* Mount count */
  _{——}s16 s_max_mnt_count;  /* Maximal Mount count */
  _{——}u16 s_magic;  /* Magic signature */
  _{——}u16 s_state;  /* File system state */
  _{——}u16 s_errors;  /* Behavior when detecting errors */
  _{——}u16 s_minor_rev_level;  /* Minor revision level */
  _{——}u32 s_lastcheck;  /* Time of last check */
  _{——}u32 s_checkinterval;  /* Maximum time between checks */
  _{——}u32 s_creator_os;  /*OS(0:Linux, 1:Hurd, 2:xasix) */
  _{——}u32 s_rev_level;  /* Revision level */
  _{——}u16 s_def_resuid;  /* Default uid for reserved blocks */
  _{——}u16 s_def_resgid;  /* Default gid for reserved blocks */
  _{——}u32 s_first_ino;  /* First non-reserved inode */
  _{——}u16 s_inode_size;  /* Size of Inode structure */
  _{——}u16 s_block_group_nr;  /* Block group # of this
              superblock */
  _{——}u32 s_feature_compat;  /* Compatible feature set */
  _{——}u32 s_feature_incompat;  /* Incompatible feature set */
  _{——}u32 s_feature_ro_compat;  /* Readonly-compatible feature
              set */
  _{——}u8 s_uuid[16];  /* 128-bit uuid for volume */
  char s_volume_name[16];  /* volume name */
  char s_last_mounted[64];  /* Directory where last
              mounted */
  _{——}u32 s_algorithm_usage_bitmap;  /* For compression */
  _{——}u8 s_prealloc_blocks;  /* Nr of blocks to try to
              preallocate */
  _{——}u8 s_prealloc_dir_blocks;  /* Nr to preallocate for
              dirs */
  _{——}u16 s_padding1;
  _{——}u32 s_reserved[204];  /* Padding to the end of block */
};
```

The Group Descriptor contains the information on the start point and sizes of the Block Bitmap, Inode Bitmap, and Inode Table as follows. The Group Descriptor of the Block Group maintain an identical content as the Super Blocks.

```
struct ext2_group_desc{
  _{——}u32 bg_block_bitmap;  /* Blocks Bitmap Block */
  _{——}u32 bg_inode_bitmap;  /* Inodes Bitmap Block */
  _{——}u32 bg_inode_table;  /* Inodes Table Block */
  _{——}u16 bg_free_blocks_count; /* Free Blocks count */
  _{——}u16 bg_free_inodes_count; /* Free Inodes count */
  _{——}u16 bg_used_dirs_count;  /* Directories count */
  _{——}u16 bg_pad;
  _{——}u32 bg_reserved[3];
};
```

The Block Bitmap shows whether or not to use the Block and the Inode Bitmap shows whether or not to use the Inode.

The Inode is a unit for representing a file (directory, link, etc.) and the information on route, position, size, type (file/directory/symbolic link/fifo, or the like), access control, and the like related to the file of each Inode, is stored in the Inode table as follows.

```
struct ext2_inode {
_{——}u16 i_mode;  /* File mode */
_{——}u16 i_uid;  /* Low 16 bits of Owner Uid */
_{——}u32 i_size;  /* Size in bytes */
_{——}u32 i_atime;  /* Access time */
_{——}u32 i_ctime;  /* Creation time */
_{——}u32 i_mtime;  /* Modification time */
_{——}u32 i_dtime;  /* Deletion time */
_{——}u16 i_gid;  /* Low 16 bits of Group Id */
_{——}u16 i_links_count; /* Links count */
_{——}u32 i_blocks;  /* Blocks count */
_{——}u32 i_flags;  /* File flags */
union {
  struct {
    _{——}u32 l_i_reserved1;
  } linux1;
  struct {
    _{——}u32 h_i_translator;
  } hurd1;
  struct {
    _{——}u32 m_i_reserved1;
  } masix1;
} osd1;  /* OS dependent 1 */
_{——}u32 i_block[EXT2_N_BLOCKS]; /* Pointers to blocks */
_{——}u32 i_generation;  /* File version (for NFS) */
_{——}u32 i_file_acl;  /* File ACL */
_{——}u32 i_dir_acl;  /* Directory ACL */
_{——}u32 i_faddr;  /* Fragment address */
union {
  struct {
    _{——}u8 l_i_frag;  /* Fragment number */
    _{——}u8 l_i_fsize;  /* Fragment size */
    _{——}u16 i_pad1;
    _{——}u16 l_i_uid_high;  /* these 2 fields */
    _{——}u16 l_i_gid_high;  /* were reserved2[0] */
    _{——}u32 l_i_reserved2;
  } linux2;
  struct {
    _{——}u8 h_i_frag;  /* Fragment number */
    _{——}u8 h_i_fsize;  /* Fragment size */
    _{——}u16 h_i_mode_high;
    _{——}u16 h_i_uid_high;
    _{——}u16 h_i_gid_high;
    _{——}u32 h_i_author;
  } hurd2;
  struct {
    _{——}u8 m_i_frag;  /* Fragment number */
    _{——}u8 m_i_fsize;  /* Fragment size */
    _{——}u16 m_pad1;
    _{——}u32 m_i_reserved2[2];
  } masix2;
} osd2;  /* OS dependent 2 */
};
```

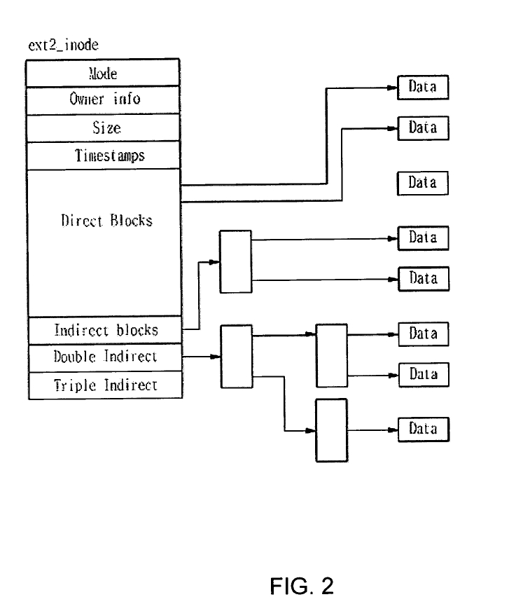

FIG. 2 is a drawing for illustrating a structure of an Inode.

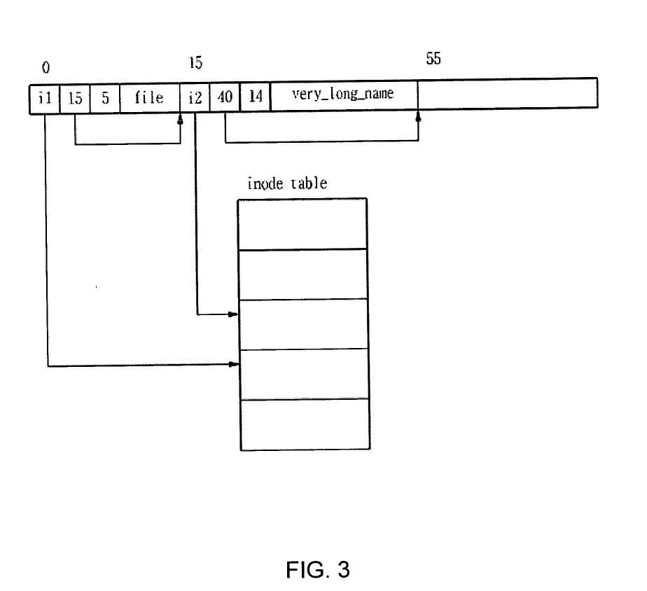

The data block contains all of the data indicated by the Inode in the Inode table. FIG. 3 is a drawing schematically illustrating a structure of the directory entry existing in the data block, which can be represented as follows.

```
struct ext2_dir_entry_2 {
  _{——}u32 inode;  /* Inode number */
  _{——}u16 rec_len;  /* Directory entry length */
  _{——}u8 name_len;  /* Name length */
  _{——}u8 file_type;
  char name[EXT2_NAME_LEN]; /* File name */
};
```

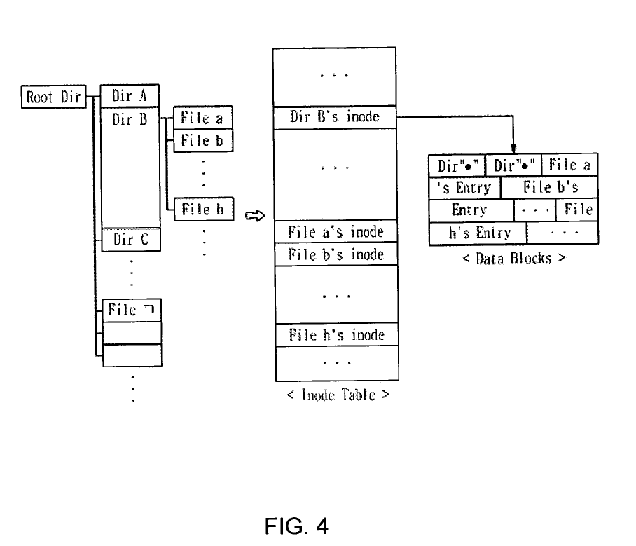

FIG. 4 is a drawing illustrating an Inode table and a data block representing entire structure of the directory tree. In this directory tree example, there are directories (A, B, C, . . . ) and files ( [symbol] , [symbol] , [symbol] , . . . ) under the root directory and files (a, b, c, . . . , h, . . . ) under the directory B.

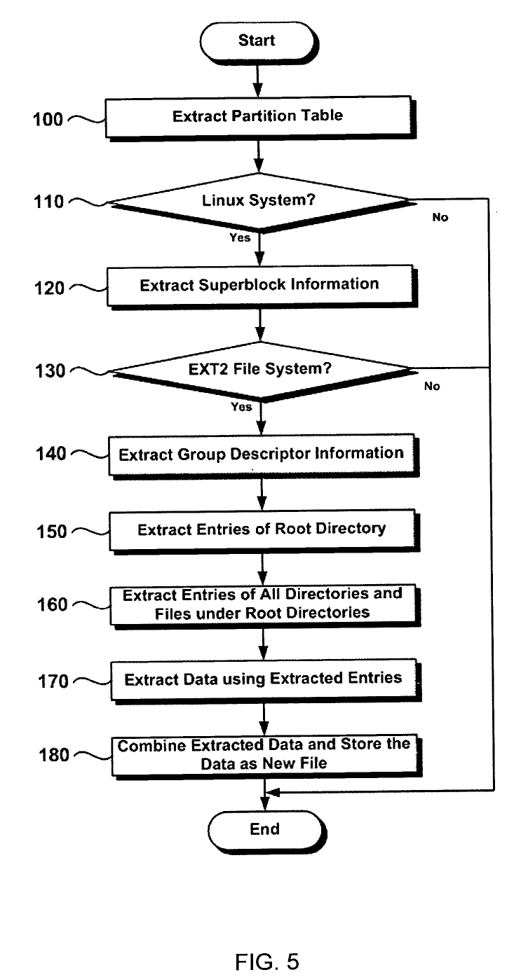

FIG. 5 is a flowchart illustrating a data recovery method of an EXT2 file system according to an embodiment of the present invention.

Referring to FIG. 5, in the data recovery method of the present invention firstly a partition table is extracted from the storage medium at step 100 and entries of directories and files are extracted from the partition using the extracted partition table at steps 120 and 140 to 160. Next, the corresponding data to be recovered are extracted using the entries at step 170 and then the extracted data are combined so as to be stored as a new file at step 180.

At step 100, in case that the partition table is damaged the data are read by unit of sector and then it is checked that there is the information matching a predetermined file system format.

At step 120, the super block information is extracted, and at step 140 the group descriptor information is extracted using the super block information. And then the entries of the directories and files of all the level below the root directory with reference to the Inode table indicated by the group descriptor information are extracted at steps 150 to 160.

At step 120, it is previously checked whether or not the super block is damaged while the super block information is extracted from the partition and only the non-damaged super block is extracted. At step 130 before step 140, it is checked whether or not the partition is using the EXT2 file system.

The data recovery method further includes the step of storing a new file in an exterior storage device or other partition different from the partition in which the data to be recovered.

In the above structured file recovery method, the data recovery procedure of the EXT2 file system will be described in more detail with reference to FIG. 1 to FIG. 5.

Firstly, the partition table is extracted so as to obtain the information on the disk at step 100. The partition table is extracted from the MBR and there exists an index (0xAA55) for recognizing the MBR at the end of the first sector of the disk. Except for the 0xAA55 from the end of the MBR, reversed 64 bytes are occupied by the partition table.

When the 0×AA55 does not exist or the partition table is partially damaged, it may be impossible to read the logical drive information of the hard disk.

In this case, the logical drive information can be obtained by reading the hard disk by unit of sector and checking whether or not there exists the information matching the predetermined file system format (super block). At this time, the sector regions can be inputted by a user. Accordingly, even when the hard disk is formatted by user's mistake, if the disk is not overwritten, the logical drive information can be obtained in that manner.

Next, if the logical drive to be recovered is selected by the user, the super block information is extracted from the corresponding partition at step 120. Here, the selected logical drive is preferably the EXT2 file system implemented according to the present invention. However, since the data recovery method may differently be applied depending on the file system, it is required to check the type of the file system of the selected logical drive.

For this purpose, it is determined whether or not an operating system set value of the extracted partition table indicates Linux at step 110. The partition table can contain the information of 4 partitions and each partition is expressed by 16 bytes.

The fifth byte among the 16 bytes indicates the operating system of the corresponding partition such that 0x83 of this value is for Linux and 0x07 is for NTFS file system.

If it is determined, at step 100, that the operating system is not Linux, the recovery procedure is terminated. On the other hand, if the operating system is Linux, the super block information is extracted from the corresponding partition at step 120. Next, it is determined whether or not a compatible feature set value of the extracted super block is EXT2 at step 130. The value of “0” indicates EXT2 and “4” indicates EXT3 file system.

At step 120, it is preferable that the super block information is extracted from the block group 0. However, since the super block existed in the block group 0 is likely to be infected by virus, the super block information is extracted after inspecting whether or not the super block of the block group 0 is damaged.

In order to determined whether or not the super block is damaged, a Magic signature, an OS, and a Revision level values are checked. The values of Magic signature (s_magic), OS (s_creator_os), and Revision level (s_rev_level) should have respective 0xEF53, 0, and 0 or 1.

When the super block is damaged, information on the super block of the next block group according to the revision level is extracted. That is, the super block information of the next block group can be extracted by inspecting the data satisfying the super block format in unit of sector.

If the revision level is 0, the super block is positioned at every block groups. However, if the revision level is greater than 1, the super block is positioned at the block groups of 0th and 1th followed by the powers of 3, 5, and 7 {i.e., 3, 5, 7, 9 (=32), 25 (=52), 49(=72), 27(=3′), 125(=53), 343(=7), . . . }.

If it is determined that the file system is EXT2 in this manner, the group descriptor information is extracted using the super block information in order to grasp the entire structure of the partition.

The number of entire block groups can be obtained by dividing the value of s_blocks_counter of the super block information by the value of s_blocks_per_group. The group descriptors as such number of the entire block groups are read.

By extracting the super block information and the group descriptor information, it is possible to distinguish the block groups included in the partition.

Next, referring to the Inode table indicated by the extracted group descriptor, the entries of the root directory are extracted at step 150. The information of the root directory is stored in the second Inode of the Inode table and the entries of the root directory are stored in the data block indicated by the second Inode.

And, in such a manner, the entries of the directories and files to every levels below the root directory are extracted at step 150.

At step 150, even though it is possible to show the user the list of all the extracted directories and files, it prefers to show the files belonged to the root directory and the directories of the level right below the root directory.

In latter case, when the user selects to see a directory, it is possible that the selected directory and right-below level directories and files contained in the selected directory are shown.

Next, if a directory or a file is selected to recover, the data is extracted from the data block using the extracted entries at step 170.

Next, the extracted data are combined so as to be stored as a new file at step 180. Here, the combined data is equal to or larger than the original data in size such that it is preferred to cut off the end of the data such that the size of the new file is identical with that of the original one.

For example, assuming that 10 data blocks, each of which is 4 Kbytes long, are combined and the original data are 38 Kbytes, the last 2 Kbytes of the 40-Kbyte data are discarded such that the remaining 38-Kbyte data is stored as the new file.

The information and data extracted from step 100 to 170 are stored in a memory and the new file is preferably stored in an exterior storage device such as a hard disk and a floppy disk or another partition rather than the partition in which the data to be recovered is stored. In case that the file or directory is simply deleted or infected by a virus, it is possible to recover the file or directory in the same manner.

In the meantime, as another method to recover the typically deleted file, the Inode of the deleted file is retrieved through the steps 140 to 170 and preferably retrieved right after the step 160.

During the deletion of the file, the Inode number field of the directory entry corresponding to the file is cleared to 0 and the deletion time is set in the Inode having the information of the file. Also, the super block and the group descriptor information are modified.

In this embodiment, the directory entry of which Inode number field is cleared to 0 is retrieved and only the retrieved directory and the files belonged to the directory are shown. However, it is also possible to retrieve to show the Inode in which the deleted time is set.

Next, if the file to be recovered is selected, the steps 170 and 180 are sequentially carried out.

As described above, the present invention is explained in relation with EXT2 file system. However, since the EXT3 file system has the same physical structure with the EXT2, the data recovery method can be identically adopted to the EXT3 file system except that the deleted files are not recovered in the EXT3 file system.

While this invention has been described in connection with what is presently considered to be the most practical and preferred embodiment, it is to be understood that the invention is not limited to the disclosed embodiments, but, on the contrary, is intended to cover various modifications and equivalent arrangements included within the sprit and scope of the appended claims.

As described above, in the present invention the damaged or deleted files can be recovered in the EXT2 file system without additional program previously installed. And, it is possible to recover the data as long as the data is not overwritten by other data.

Also, the data recovery is possible even when the disk is not recognized due to the damage of the partition table of the MBR region.

Also, it is possible to recover the damaged data even when the computer is not normally rebooted due to the errors of the super block.

1. A data recovery method for a Second Extend File System (EXT2) comprising:
extracting partition table from a storage medium stored data to be recovered;
extracting entries of directories and files from a partition using the extracted partition table;
extracting corresponding data using the entries; and
combining the extracted data so as to be stored as a new file.

2. The data recovery method of claim 1, wherein the step of extracting the entries includes:
extracting super block information from the partition;
extracting group descriptor information using the super block information; and
extracting the directory and file entries of all the level under a root directory referring to an Inode table which is indicated by the group descriptor information.

3. The data recovery method of claim 2, wherein the step of extracting the super block information includes:
checking whether or not super block are damaged; and
extracting the super block that are not damaged.

4. The data recovery method of claim 2, wherein the step of extracting the entries further includes:
checking whether or not the partition is for the EXT2 file system.

5. The data recovery method of claim 1, wherein the step of extracting the partition table includes:
reading the storage medium in unit of sector when the partition table is damaged; and
checking whether the data matching with a predetermined file system type exists.

6. The data recovery method of claim 1, wherein the new file is stored in an exterior storage device or other partition different from the partition in which the data to be recovered are stored.

7. The data recovery method of claim 1, wherein the step of extracting the entries includes:
extracting super block information from the partition;
extracting group descriptor information using the super block information; and
extracting entries of the directories and files of which Inode number fields are cleared referring to an Inode table indicated by the group descriptor information.

8. The data recovery method of claim 7, wherein the directories and files are indicated in the Inode table so as to have deletion times.

9. The data recovery method of claim 8, wherein the step of extracting the super block information includes:
checking whether or not super block are damaged; and
extracting the super block that are not damaged.

10. The data recovery method of claim 8, wherein the step of extracting the partition table includes:
reading the storage medium in unit of sector when the partition table is damaged; and
checking whether the data matching with a predetermined file system type exists.

11. A computer readable storage medium storing a data recovery program for a Second Extend File System (EXT2), the program comprising the processes of:
extracting partition table from a storage medium stored data to be recovered;
extracting entries of directories and files from a partition using the extracted partition table;
extracting corresponding data using the entries; and
combining the extracted data so as to be stored as a new file.

12. The computer readable storage medium of claim 11, wherein the process of extracting the entries includes:
extracting super block information from the partition;
extracting group descriptor information using the super block information; and
extracting the directory and file entries of all the level under a root directory referring to an Inode table which is indicated by the group descriptor information.

13. The computer readable storage medium of claim 12, wherein the process of extracting the super block information includes:
checking whether or not super block are damaged; and
extracting the super block that are not damaged.

14. The computer readable storage medium of claim 12, wherein the process of extracting the entries further includes:
checking whether or not the partition is for the EXT2 file system.

15. The computer readable storage medium of claim 11, wherein the process of extracting the partition table includes:
reading the storage medium in unit of sector when the partition table is damaged; and
checking whether the data matching with a predetermined file system type exists.

16. The computer readable storage medium of claim 11, wherein the new file is stored in an exterior storage device or other partition different from the partition in which the data to be recovered are stored.

17. The computer readable storage medium of claim 11, wherein the process of extracting the entries includes:
extracting super block information from the partition;
extracting group descriptor information using the super block information; and
extracting entries of the directories and files of which Inode number fields are cleared referring to an Inode table indicated by the group descriptor information.

18. The computer readable storage medium of claim 17, wherein the directories and files are indicated in the Inode table so as to have deletion times.

19. The computer readable storage medium of claim 17, wherein the process of extracting the super block information includes:
checking whether or not the super block are damaged; and
extracting the super block that are not damaged.

20. The computer readable storage medium of claim 17, wherein the process of extracting the partition table includes:
reading the storage medium in unit of sector when the partition table is damaged; and
checking whether the data matching with a predetermined file system type exists.
